(19) United States
(12) Patent Application Publication
(10) Pub. No.: US 2008/0008201 A1
(43) Pub. Date: Jan. 10, 2008

(54) Communication terminal, a method for communication, and a program strorage medium storing a program thereof

(75) Inventors: Akira Imahase, Fukuoka (JP); Takeshi Matsunaga, Fukuoka (JP); Shinya Yamamura, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/822,549

(22) Filed: Jul. 6, 2007

(30) Foreign Application Priority Data
Jul. 7, 2006 (JP) 2006-187907

(51) Int. Cl. H04L 12/56

(52) U.S. Cl. 370/401

(57) ABSTRACT

Communication terminals are provided with a short range wireless communication interface. Some communication terminals are also provided with a long range wireless communication interface. A communication terminal having both interfaces is determined to become a segment manager by a plurality of communication terminals. A segment manager and its neighboring communication terminals constitute a segment and communicate with each other via the short range wireless communication interface. A segment manager distributes segment information and collects terminal information from communication terminals that belong to its own segment. The segment managers communicate with each other via the long range wireless communication interface. The segment managers exchange the terminal information related to each segment. Communication within a segment is performed through that segment alone via the short range wireless communication interface. Communication toward the outside of that segment is performed via the short range wireless communication interface and the long range wireless communication interface.

### BACKGROUND OF THE INVENTION

1. Field of the Invention

The present invention relates to an ad hoc network, especially to a method employed by a communication terminal to form a segment in the ad hoc network.

2. Description of the Related Art

An ad hoc network has been focused recently, which is a communication network established temporarily among communication terminals that happen to be present nearby each other. The ad hoc network allows each individual communication terminal to function as a communication relay, thus realizing communication that is independent of existing infrastructure. It is, therefore, expected to be used as a communication means in case of collapse of infrastructure such as due to a disaster, or in an area where infrastructure is not prepared.

In the above-described ad hoc network, communication terminals randomly move within the network. For this reason, when the communication terminals move frequently, there is a possibility that data packets are influenced by control packets such as route finding. In addition, in the ad hoc network, because the position of a communication terminal in the network is not relevant to the address (identifiers) of the communication terminal, each communication terminal needs to handle a routing table for every destination communication terminal. Thus, there is a problem that the size of the routing table in the ad hoc network becomes larger than in the normal IP network. These problems obstruct a large-scale ad hoc network.

In order to solve these problems, LANMAR (Landmark Routing Protocol) has been proposed, for example, in Li Ma and Guangyu Pei, Landmark Routing Protocol (LANMAR) for Large Scale Ad Hoc Networks, Internet Draft, IETF MANET Working Group, draft-ietf-manet-lanmar-05.txt, Nov. 17, 2002. LANMAR premises that mobile communication terminals are grouped and each communication terminal is assigned an address consisting of a group ID and a host ID. LANMAR attempts to solve the above problems by sending a route notification by group and handling a routing table by group.

However, LANMAR does not cover a mechanism of grouping and address assignment. Taking into consideration an ad hoc network which indefinite number of communication terminals that shift in to and out from a segment, dynamic grouping and dynamic address assignment are required. Variable address of a communication terminal raises another problem that communication becomes no longer seamless.

### SUMMARY OF THE INVENTION

The present invention has been conceived in order to solve the problems described above, and an object of the present invention is to provide a method of realizing seamless communication in an ad hoc network while dynamically splitting the ad hoc network into segments.

According to the present invention, an ad hoc network is dynamically split into segments, so that dynamic grouping and dynamic address assignment are performed. In addition, information relating to mobile communication terminals is shared among segment managers (which correspond to landmarks of LANMAR) that manage segments, to acquire a route to a communication terminal that has shifted from one segment to another, thus realizing seamless communication.

One aspect of the present invention provides a communication terminal which performs communication through a primary network and communication through a secondary network. The primary network is split into a plurality of segments. The segment is constituted with a segment manager and subordinate terminals. The segment manager manages the segment. The communication terminal includes: a segment information storage which stores a first unique address of the communication terminal; a first interface which performs communication through the primary network; a second interface which performs communication through the secondary network; a communication control part which transmits an offer of becoming a segment manager of a first segment via the first interface, receives an approval for the offer via the first interface, transmits prefix information indicating the first segment via the first interface, receives a second unique address of a second subordinate terminal which joins the first segment via the first interface, transmits the second unique address and the first unique address via the second interface, and receives a fourth unique address of a fourth subordinate terminal which belongs to a third segment and a third unique address of a segment manager which manages the third segment via the second interface; and a segment management part which generates the prefix information from the first unique address in a predefined manner.

The communication control part of the communication terminal may receive a packet which includes a fifth destination address and a fifth unique address via the first communication interface. The communication control part of the communication terminal may forward the packet via the first interface when the fifth destination address indicates a subordinate terminal in the first segment. The communication control part of the communication terminal may forward the packet via the second interface when the fifth destination address indicates a segment manager or a subordinate terminal in a segment other than the first segment.

The communication terminal may include a routing information storage which stores a triplet that contains a destination address which indicates an ultimate destination, a forwarding address which indicates a present destination, and interface information which indicates the first interface or the second interface.

The communication control part of the communication terminal may receive a packet which includes a fifth destination address and a fifth unique address via the first communication interface. The communication control part of the communication terminal may forward, when it has found a triplet containing the fifth destination address as the destination address in the routing information storage, the packet to the forwarding address which is contained in the found triplet via a communication interface which is indicated by the interface information that is contained in the found triplet. The communication control part of the communication terminal may forward the packet to the third unique address via the second interface when the fifth destination address is able to be generated from the fourth unique address and the third unique address in a predefined manner.

The segment information storage of the communication terminal may store a sixth destination address and a seventh unique address. The sixth destination address is of a sixth subordinate terminal which has shifted out from the first segment. The seventh unique address is of a segment manager which manages a seventh segment to which the sixth subordinate terminal belongs. The communication control part of the communication terminal may, when it has received a packet including the sixth destination address, forward the packet to the seventh unique address via the second interface.

Another aspect of the present invention provides a method for performing communication through a primary network and communication through a secondary network. The primary network is split into a plurality of segments. The segment is constituted with a segment manager and subordinate terminals. The segment manager manages the segment. The method is executed by a communication terminal. The communication terminal includes a segment information storage which stores a first unique address, a first interface, and a second interface. The first unique address is of the communication terminal. The first interface is for performing communication through the primary network. The second interface is for performing communication through the secondary network. The method includes the steps of: transmitting an offer of becoming a segment manager of a first segment via the first interface; receiving an approval for the offer via the first interface; generating prefix information from the first unique address in a predefined manner; transmitting the prefix information via the first interface; receiving a second unique address of a second subordinate terminal which joins the first segment via the first interface; transmitting the second unique address and the first unique address via the second interface; and receiving a fourth unique address of a fourth subordinate terminal which belongs to a third segment and a third unique address of a segment manager which manages the third segment via the second interface.

Yet another aspect of the present invention provides a program storage medium which a computer is able to read. The program storage medium stores a program of instructions for the computer to execute a method for communication through a primary network and communication through a secondary network. The primary network is split into a plurality of segments. The segment is constituted with a segment manager and subordinate terminals. The segment manager manages the segment. The computer is installed in a communication terminal. The communication terminal includes a segment information storage which stores a first unique address, a first interface, and a second interface. The first unique address is of the communication terminal. The first interface is for performing communication through the primary network. The second interface is for performing communication through the secondary network. The method includes the steps of: transmitting an offer of becoming a segment manager of a first segment via the first interface; receiving an approval for the offer via the first interface; generating prefix information from the first unique address in a predefined manner; transmitting the prefix information via the first interface; receiving a second unique address of a second subordinate terminal which joins the first segment via the first interface; transmitting the second unique address and the first unique address via the second interface; and receiving a fourth unique address of a fourth subordinate terminal which belongs to a third segment and a third unique address of a segment manager which manages the third segment via the second interface.

These aspects do not necessarily represent essential features of the present invention, but any combination of these features may be regarded as part of the present invention.

As described above, according to the present invention, a segment manager is determined and the segment manager distributes segment information including prefix information so that communication terminal which received the segment information is able to set its address (dynamic address setting) in accordance with the segment information, that is, dynamic grouping can be accomplished. Thus, in cooperation with LANMAR, it is expected to improve the scalability of the network, which is the problem of an ad hoc network.

In addition, though dynamic change of address causes worry about cut off of communication, by sharing terminal information (“terminal information” refers to information on each communication terminal which belongs to a segment) among segment managers and by forwarding packets, seamless communication is expected even when an address is changed by a shift of a communication terminal.

### BRIEF DESCRIPTION OF THE DRAWINGS

FIG. 1 is a system configuration diagram according to a first embodiment of the present invention;

FIG. 2 is a functional block diagram showing the functions of a communication terminal;

FIG. 3A is a data structure of the segment information;

FIG. 3B is a data structure of internal terminal information;

FIG. 3C is a data structure of external terminal information;

FIG. 4 is a data structure of the policy information DB;

FIG. 5 is a data structure of the routing information;

FIG. 6A shows a process sequence of a communication terminal which is a candidate for a segment manager;

FIG. 6B shows a process sequence of a neighboring communication terminal of the candidate;

FIG. 7 shows a process sequence of dynamic address setting;

FIG. 8 shows a process sequence in which internal terminal information is entered in the segment manager;

FIG. 9 shows a process sequence in which external terminal information is entered in the segment manager;

FIG. 10 shows a process sequence in which a data packet addressed to an external communication terminal is forwarded by the segment manager of the source segment;

FIG. 11 shows a process sequence in which a data packet forwarded from the source segment is forwarded within a destination segment;

FIG. 12 is a functional block diagram of a communication terminal according to a second embodiment of the present invention;

FIG. 13A shows a process sequence of a segment manager which is running short of battery capacity;

FIG. 13B shows a process sequence of a neighboring communication terminal of the segment manager;

FIG. 14 is a process sequence of priority adjustment process of a communication terminal;

FIG. 15 explains first example;

FIG. 16 explains second example;

FIG. 17 explains third example;

FIG. 18 explains fourth example;

FIG. 19 explains fifth example; and

FIG. 20 shows an example of the residual battery capacity priority correspondence table.

### DESCRIPTION OF THE PREFERRED EMBODIMENTS

### First Embodiment of the Present Invention

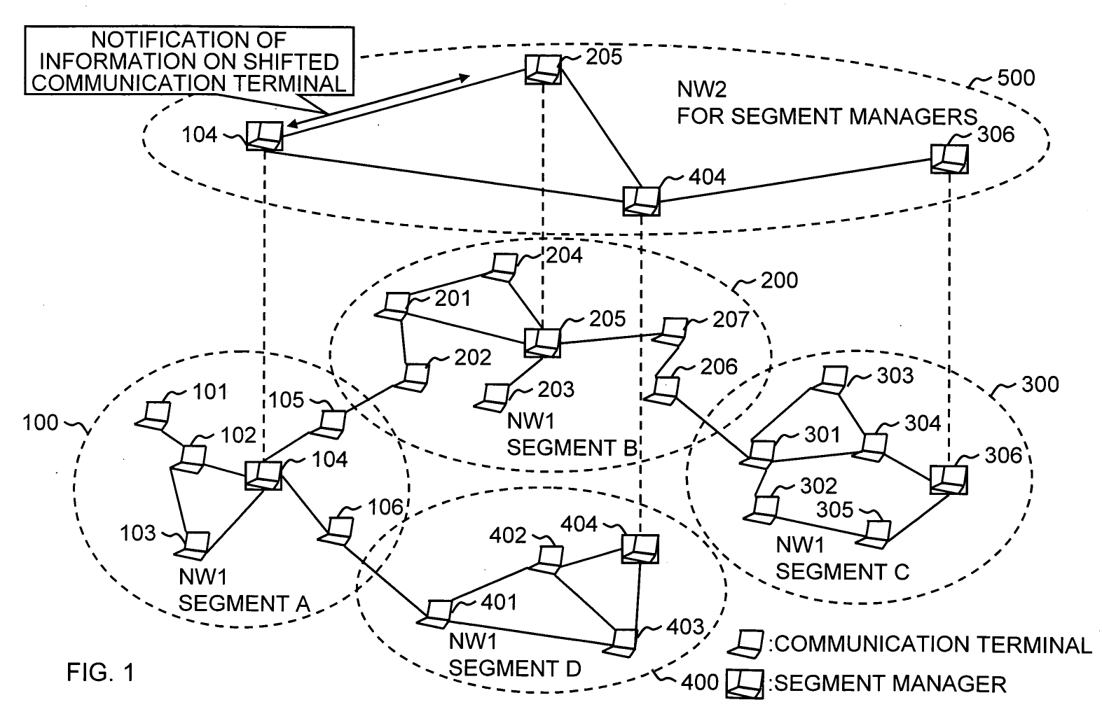

FIG. 1 is a system configuration diagram according to a first embodiment of the present invention.

A communication terminal that attempts to join a primary ad hoc network (NW1), in cooperation with neighboring communication terminals, determines a segment manager in accordance with policy information that is preset on each communication terminal (when a segment has been already formed, the communication terminal joins to the segment or becomes itself a segment manager and a new segment is formed). A communication terminal that has become a segment manager periodically distributes segment information (including prefix information). A communication terminal that has received the segment information joins the segment by changing its address (prefix) in accordance with the segment information. A communication terminal that has received segment information from a plurality of segment managers determines which segment to join by reference to the number of hops to the segment managers, or the like. The communication terminal, when shifted from one segment to another, will join a destination segment by changing its address in accordance with the segment information received from the segment manager of the destination segment.

Each of the segment manager and the communication terminals that belong to the segment activates LANMAR to create routes to communication terminals within a scope (directly communicable), routes to communication terminals within the same segment, and routes to other segment managers. Owing to LANMAR, each segment manager can find all communication terminals that belong to the segments.

Each segment manager is provided with a long range wireless communication interface that is capable of establishing a long distance communication, in addition to a short range wireless communication interface that is used for communication through the primary ad hoc network (NW1). Other than the primary ad hoc network (NW1), a secondary ad hoc network (NW2) is constituted with only the segment managers. Communication through the secondary ad hoc network (NW2) is performed via the long range wireless communication interface. The routing protocol in the secondary ad hoc network (NW2) is not specifically limited.

In the primary ad hoc network (NW1), a communication terminal freely shifts between segments, from a source segment to a destination segment. The segment manager in the source segment keeps information of the shifted communication terminal for a certain period of time. On the other hand, the segment manager of the destination segment notifies other segment managers, through the secondary ad hoc network (NW2), of information on the communication terminal that newly joined its segment. The information includes a link local address and a new address of the communication terminal. The segment managers that have received the notification keep the information for a certain period of time.

When a communication terminal shifts from one segment to another segment (namely, when the address of the communication terminal is changed), a packet addressed to the communication terminal may be forwarded to the source segment. In this case, a communication terminal that belongs to the source segment forwards the packet to the segment manager. The segment manager that has finally received the packet changes the destination address of the packet and executes packet forwarding through the primary ad hoc network (NW1), when it can acquire the new destination address by retrieving it on the basis of the link local address of the shifted communication terminal. The packet is then forwarded to the destination communication terminal by LANMAR. When it is determined on the basis of the number of hops, or the like, that the shifted communication terminal is remotely located, the packet forwarding is executed not through the primary ad hoc network (NW1) but through the secondary ad hoc network (NW2) constituted with the segment managers. By using the secondary ad hoc network (NW2) constituted with the segment managers, a load on the primary ad hoc network (NW1) may be reduced.

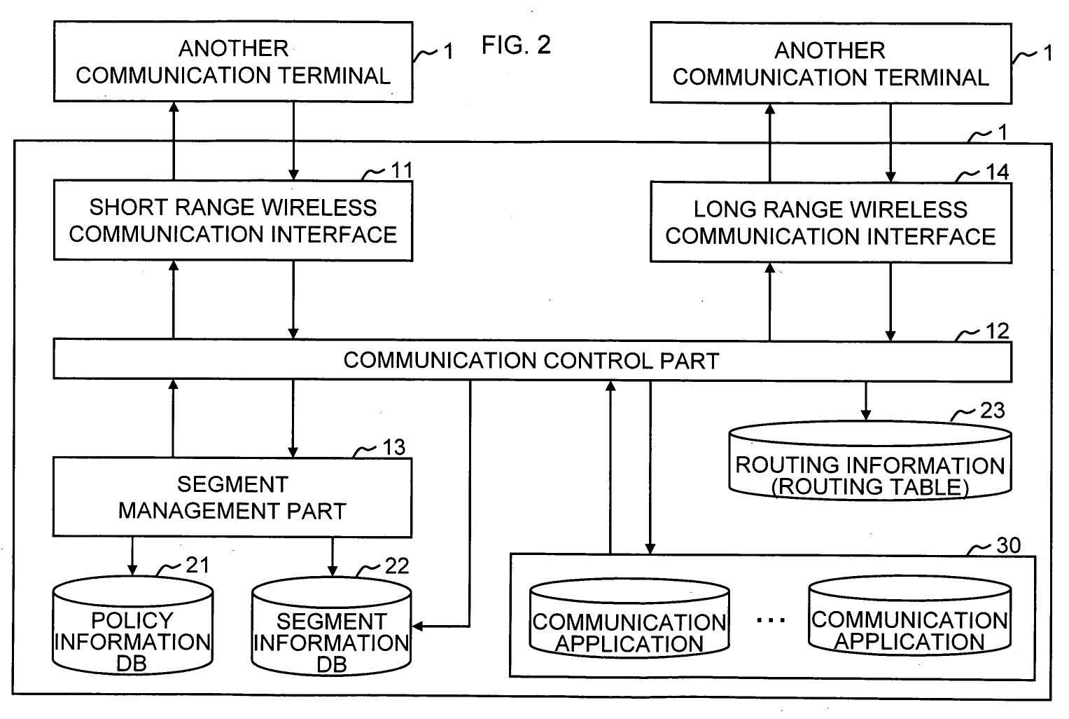

FIG. 2 is a functional block diagram showing the functions of a communication terminal 1. The following will describe each of the functions.

### Short Range Wireless Communication Interface 11

The short range wireless communication interface 11 establishes communication with other communication terminals 1 and used for communication through the primary ad hoc network (NW1). Each communication terminal 1 needs to be equipped with the short range wireless communication interface 11 to join the primary ad hoc network (NW1).

### Long Range Wireless Communication Interface 14

The long range wireless communication interface 14 establishes communication with other segment managers and used for communication through the secondary ad hoc network (NW2). The segment managers perform communication through the secondary ad hoc network (NW2) via the long range wireless communication interface 14. Each segment manager needs to be equipped with the long range wireless communication interface 14.

### Communication Control Part 12

The communication control part 12 generates routing information and executes communication control in accordance with the routing information. When the communication control part 12 has received a packet addressed to a communication terminal 1 within the same segment, which is not present in the routing information, the communication control part 12 forwards the packet to the segment manager. The segment manager that has received this packet asks segment managers of other segments for an address of the destination communication terminal 1. When the segment manager has acquired the address of the destination communication terminal 1, the communication control part 12 changes the address of the packet to forward it. When the segment manager cannot acquire the address of the destination communication terminal 1, the communication control part 12 discards the packet.

### Segment Management Part 13

The segment management part 13 selects a segment manager on the basis of policy information in association with other communication terminals 1. After the segment manager is selected, the segment management part 13 sets an IP address in accordance with segment information that is acquired from the segment manager. The segment management part 13 also manages the segment information.

Segment Information DB (Database) 22

The segment information DB 22 contains information relevant to the segment, such as the address of the segment manager and the prefix information of the segment. A communication terminal 1 that has become a segment manager keeps segment information such as a link local address of each communication terminal 1 that belongs to the segment. In addition, the segment information DB 22 also keeps information of a communication terminal 1 that has shifted out from the segment for a certain period of time.

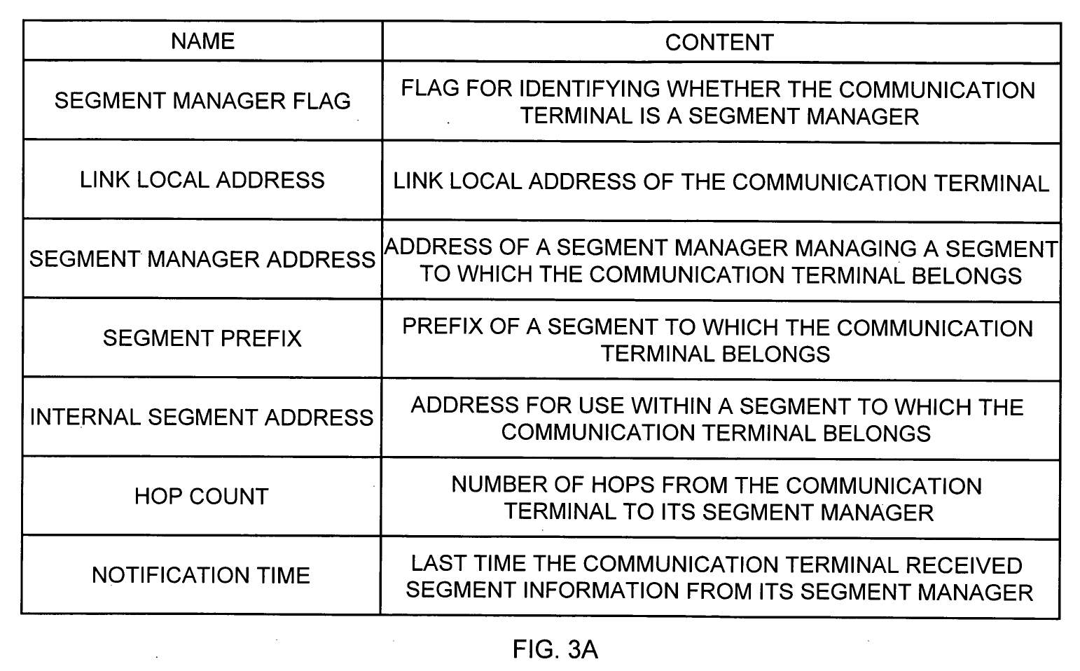

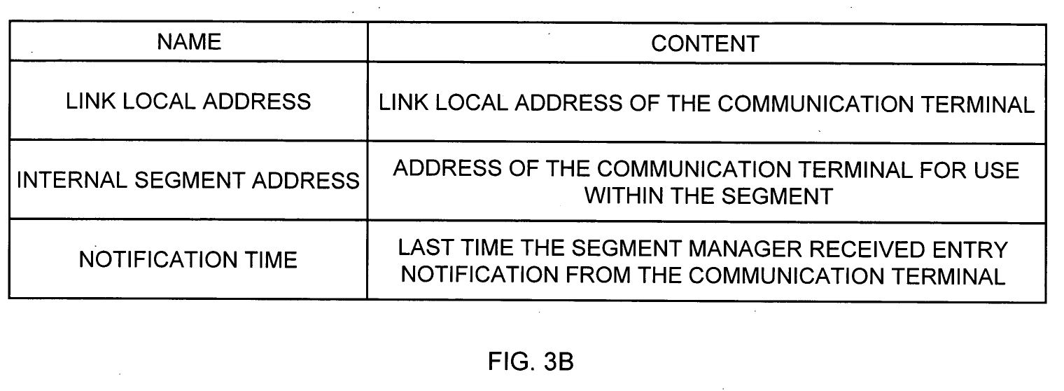

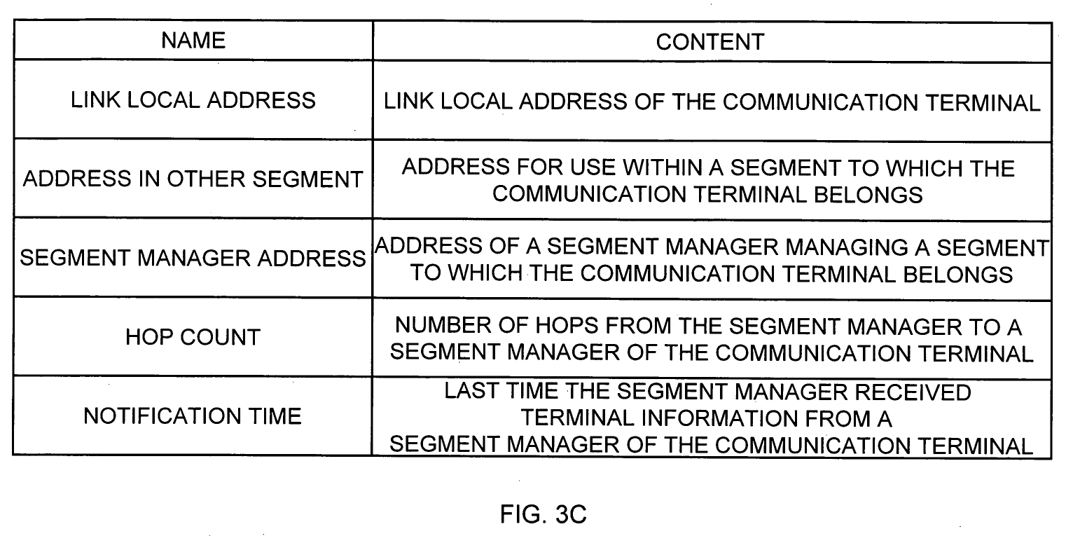

FIGS. 3A, 3B and 3C are data structures of information included in the segment information DB 22. FIG. 3A is a data structure of the segment information. FIG. 3B is a data structure of internal terminal information. The internal terminal information is the information relevant to each communication terminal which belongs to a segment and is kept by the segment manager of the segment. FIG. 3C is a data structure of external terminal information. The external terminal information is the information relevant to each communication terminal which belongs to a segment other than the segment managed by the segment manager, and is kept by the segment manager.

### Policy Information DB (Database) 21

The policy information DB 21 contains information for managing a policy relevant to addition of a segment and is preset on each communication terminal 1. The policy information DB 21 also contains information whether or not a communication terminal 1 is operable or inoperable as a segment manager. A communication terminal 1 with no long range wireless communication interface 14 is set to be inoperable as a segment manager.

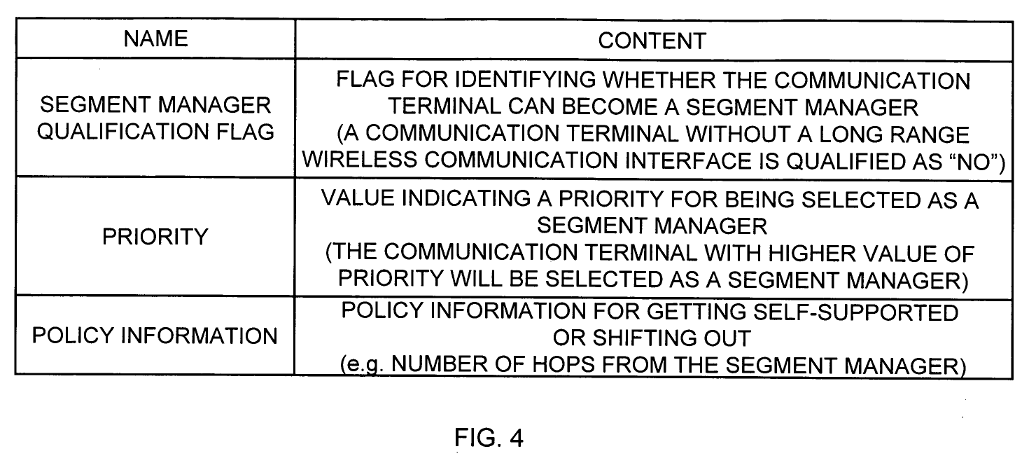

FIG. 4 is a data structure of the policy information DB 21. For example, a communication terminal 1 suitable for a segment manager is set to have a high priority, and a communication terminal 1 having sufficient processing capacity and battery capacity is set to have a high priority.

### Routing Information 23

The routing information 23 is information (a routing table) for execution of routing. The routing information 23 contains information of routes to communication terminals 1 within the scope, routes to communication terminals 1 in the same segment, and routes to segment managers of other segments.

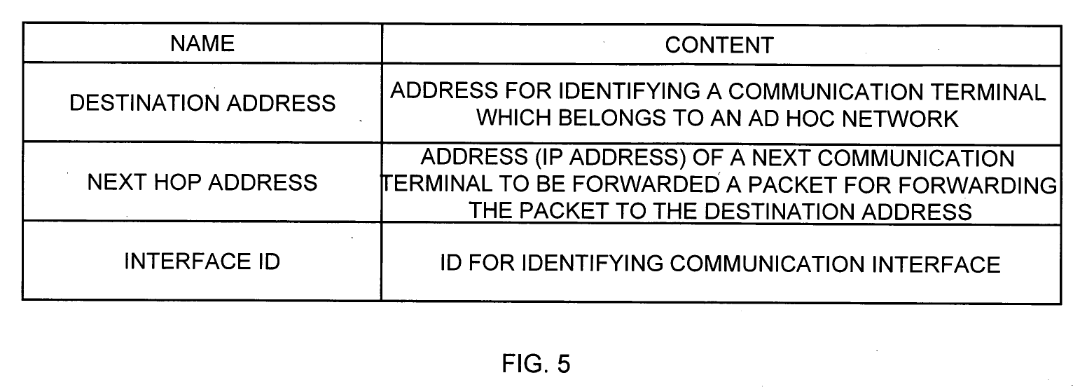

FIG. 5 is a data structure of the routing information 23.

### Communication Application

The communication application is an application program that causes the communication terminal 1 to communicate with other communication terminals 1 via the communication control part 12.

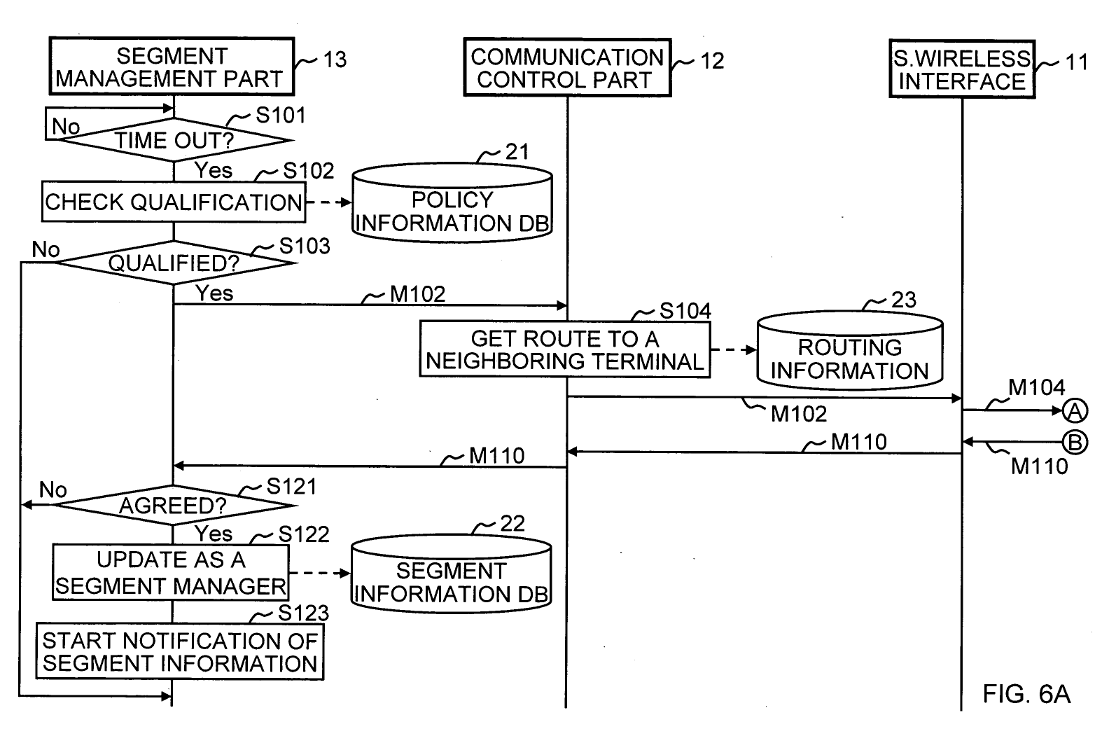

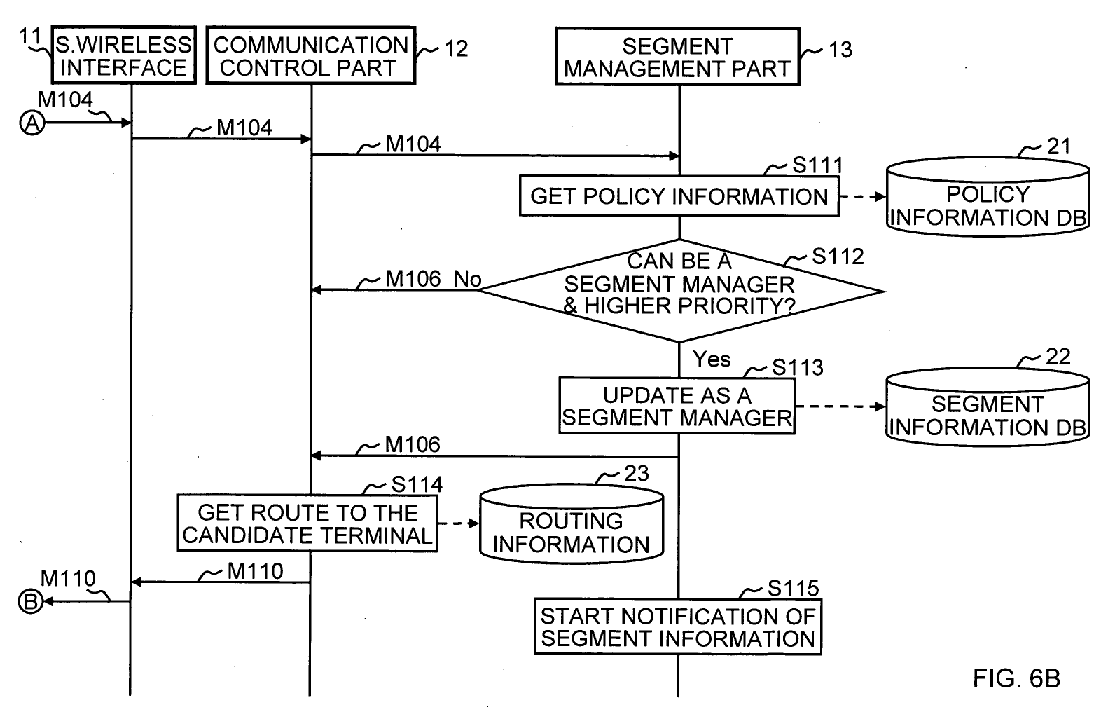

The operation diagram according to the first embodiment of the present invention is shown in FIGS. 6A to 11.

FIGS. 6A and 6B show a process sequence in which a communication terminal 1 transforms into a segment manager. First, the process sequence of transformation into a segment manager according to the first embodiment will be described with reference to FIGS. 6A and 6B. FIG. 6A shows a process sequence of a communication terminal 1 which is a candidate for a segment manager. FIG. 6B shows a process sequence of a neighboring communication terminal 1 of the candidate.

After a communication terminal 1 has joined the primary ad hoc network (NW1), it is determined whether time for reception of segment information is out (step S101). When time for reception of segment information distributed by a segment manager is out, the communication terminal 1 starts a transformation into a segment manager. When the communication terminal 1 has not received segment information for a certain period of time, the segment management part 13 references the policy information DB 21 and checks the segment manager qualification flag indicating whether the communication terminal 1 itself can become a segment manager (step S102). The segment management part 13 determines whether the communication terminal 1 can become a segment manager on the basis of the segment manager qualification flag (step S103). When the communication terminal 1 cannot become a segment manager, the communication terminal 1 does nothing. When the communication terminal 1 can become a segment manager, the segment management part 13 sends a segment manager candidate information notification request M102 to the communication control part 12 in order to notify neighboring communication terminals 1 of a segment manager candidate information M104. The segment manager candidate information M104 contains priority information that is acquired from the policy information DB 21. The communication control part 12 that has received the request from the segment management part 13 acquires, from the routing information 23, information on a route to a neighboring communication terminal 1 (step S104). The information on the route includes information of a communication terminal 1 as a next hop and information of a wireless communication interface to be used. The communication control part 12 sends a segment manager candidate information notification request M102 to the short range wireless communication interface 11 (also referred to as “S. WIRELESS INTERFACE” in the figures). The short range wireless communication interface 11 that has received the segment manager candidate information notification request M102 transmits the segment manager candidate information M104.

The communication control part 12 of a neighboring communication terminal 1 receives the segment manager candidate information M104 via the short range wireless communication interface 11. The communication control part 12 recognizes that the received information is the segment manager candidate information M104 and then notifies the segment management part 13 of the information. The segment management part 13 that has received the segment manager candidate information M104 references the policy information DB 21 (step S111), and then checks the segment manager qualification flag indicating whether the communication terminal 1 itself can become a segment manager. When the communication terminal 1 can become a segment manager, the segment management part 13 acquires priority information from the policy information DB 21. That is, it is determined whether or not the communication terminal 1 itself can become a segment manager and has a higher priority to become a segment manager than the source communication terminal 1 (step S112). When the communication terminal 1 itself cannot become a segment manager or the communication terminal 1 has an equal to or lower priority than the source communication terminal 1, the segment management part 13 sends a segment manager candidate response transmission request M106 to the communication control part 12 in order to send “segment manager OK” response back to the source communication terminal 1. When the communication terminal 1 itself can become a segment manager and has a higher priority than the source communication terminal 1, this communication terminal 1 itself becomes a segment manager. The segment management part 13 updates the segment information DB 22 in order to indicate that the communication terminal 1 operates as a segment manager (step S113). The segment management part 13 sends a segment manager candidate response transmission request M106 to the communication control part 12 in order to send “segment manager NG” response back to the source communication terminal 1. The communication control part 12 that has received the segment manager candidate response transmission request M106 transmits a segment manager candidate response M110 to the source communication terminal 1 via the short range wireless communication interface 11. Here, the communication control part 12 that has received the request from the segment management part 13 acquires, from the routing information 23, information on a route to the source communication terminal 1 (step S114). The information on the route includes information of a communication terminal 1 as a next hop and information of a wireless communication interface to be used. The communication control part 12 transmits the segment manager candidate response M110 via the short range wireless communication interface 11. Other than referencing the routing information 23, known information may be used, that is, information of the communication terminal 1 as the next hop and information of the wireless communication interface used upon reception of the segment manager candidate information M104. Then, the communication terminal 1 that has become a segment manager starts the notification operation of the segment information to other communication terminals 1 (step S115).

The segment management part 13 of the source communication terminal 1 receives the segment manager candidate response M110 from the neighboring communication terminal 1 via the short range wireless communication interface 11 and the communication control part 12. The segment management part 13 that has received the response checks the response result. The segment management part 13 determines whether the response result is OK or not (step S121). When the response is OK, this communication terminal 1 becomes a segment manager. The segment management part 13 then updates the segment information DB 22 in order to indicate that the communication terminal 1 operates as a segment manager (step S122). Then, the communication terminal 1 that has become a segment manager starts the notification operation of the segment information to other communication terminals 1 (step S123). When the response is NG, this communication terminal 1 waits for segment information notified from a neighboring communication terminal 1.

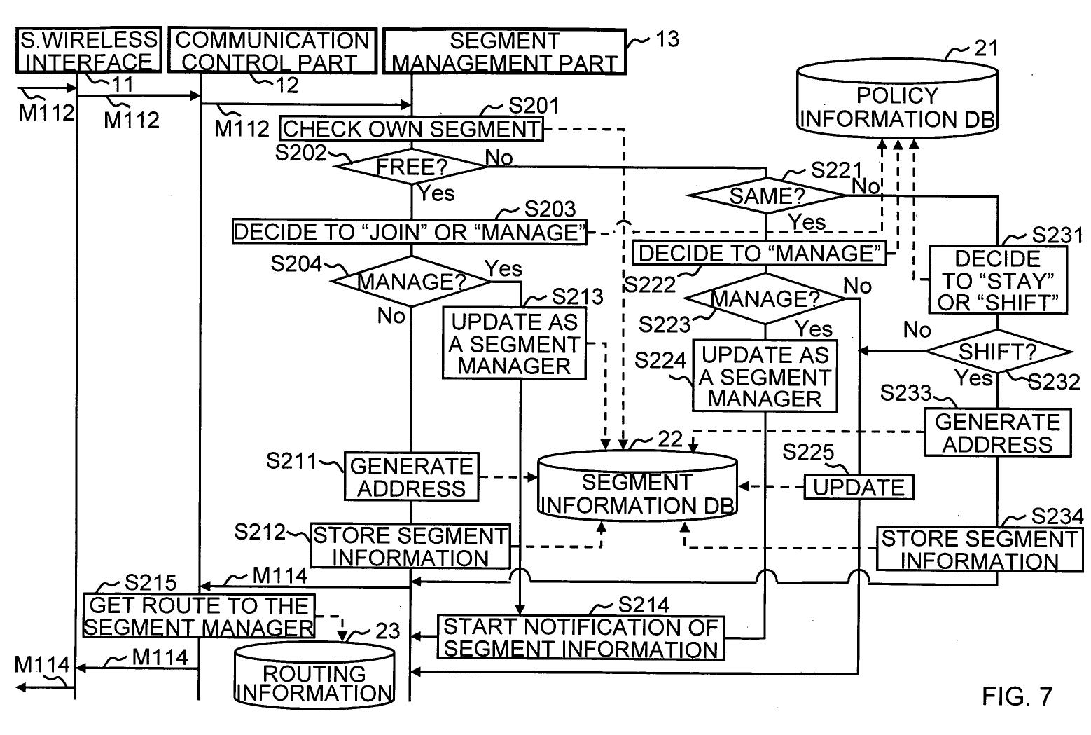

FIG. 7 shows a process sequence of dynamic address setting. The process sequence of dynamic address setting will now be described with reference to FIG. 7. A segment manager periodically distributes segment information M112. The communication control part 12 of a communication terminal 1 receives the segment information M112 via the short range wireless communication interface 11. The communication control part 12 notifies the segment management part 13 of the segment information M112. The segment management part 13 that has received the notification acquires, from the segment information DB 22, information of the segment to which the communication terminal 1 currently belongs (step S201). Here, the operation varies depending on (1) the case where the communication terminal 1 does not belong to any segment, (2) the case where the communication terminal 1 belongs to the notified segment, and (3) the case where the communication terminal 1 belongs to the segment other than the notified segment. Discrimination between the three cases (1) to (3) is made whether or not the communication terminal 1 is currently free (namely, it does not belong to any segment) (step S202) and whether or not the segment to which the communication terminal 1 currently belongs is the same as the notified segment (step S221).

In the case (1), the segment management part 13 acquires policy information from the policy information DB 21 and then decides whether the communication terminal 1 will join the notified segment, or will not join the notified segment so as to become itself a segment manager (steps S203 and S204). When the communication terminal 1 joins the segment, the segment management part 13 generates an address on the basis of the notified segment information M112, or the like, and sets the address on the short range wireless communication interface 11 (step S211). The segment management part 13 also enters the notified segment information M112 to the segment information DB 22 (step S212), and sends a segment entry notification M114 to the notification source segment manager via the communication control part 12 and the short range wireless communication interface 11. This segment entry notification M114 contains a link local address in addition to the address generated. On the other hand, when the communication terminal 1 does not join the segment and becomes itself a segment manager, the segment management part 13 updates the segment information DB 22 in order to indicate that the communication terminal 1 operates as a segment manager (step S213). Then, the segment management part 13 starts the notification operation of the segment information to other communication terminals (step S214).

In the case (2), the segment management part 13 acquires policy information from the policy information DB 21 and then decides whether the communication terminal 1 will continue to belong to the notified segment or will depart from the notified segment to become itself a segment manager (step S222 and step S223). When the communication terminal 1 continues to belong to the notified segment, the segment management part 13 updates the segment information DB 22 (with segment information reception time) (step S225). When the communication terminal 1 itself becomes a segment manager, the following steps are the same as the case (1) (step S224 and step S214).

In the case (3), the segment management part 13 acquires policy information from the policy information DB 21 and then decides whether the communication terminal 1 will continue to belong to the segment to which the communication terminal 1 currently belongs or will shift to the notified segment (step S231 and step S232). When in the former, the segment management part 13 updates the segment information DB 22 (with segment information reception time) (step S225). When in the latter, the segment management part 13 generates an address on the basis of the notified segment information M112, or the like, and then sets the address on the short range wireless communication interface 11 (step S233). Thereafter, the segment management part 13 enters the notified segment information M112 to the segment information DB 22 (step S234). Then, the segment management part 13 sends a segment entry notification M114 to the notification source segment manager via the communication control part 12 and the short range wireless communication interface 11.

The process sequence of entering terminal information will be described, in which the segment manager enters information of a communication terminal which belongs to a segment to the segment information DB 22.

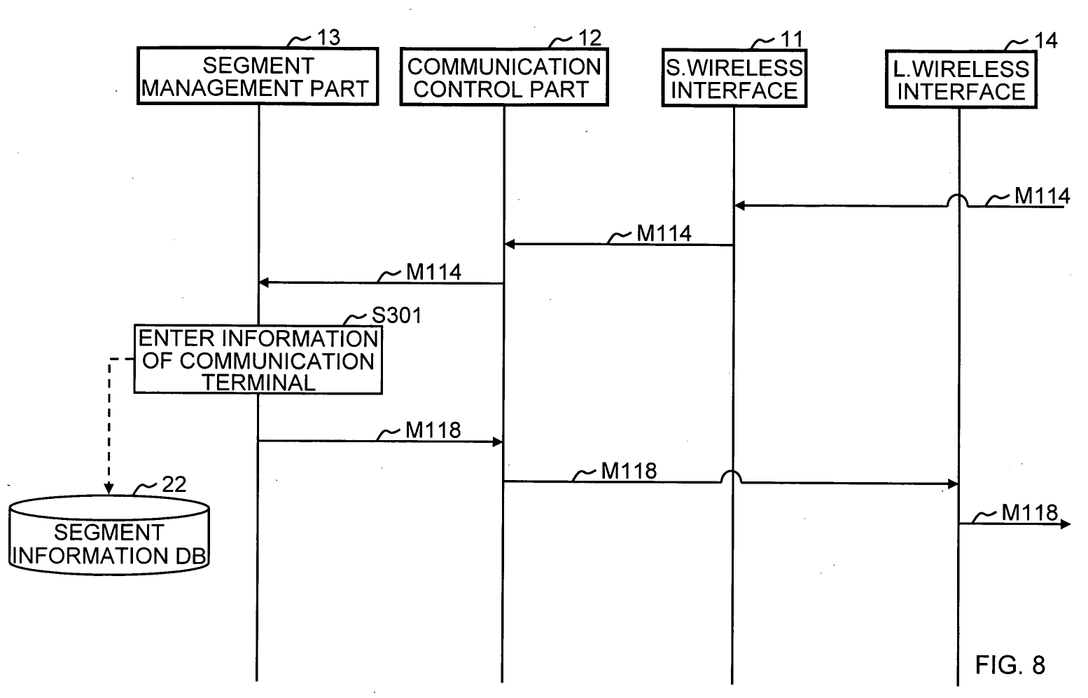

FIG. 8 shows a process sequence in which internal terminal information is entered in the segment manager. First, the entry of the terminal information related to the own segment will be described with reference to FIG. 8. When a communication terminal 1 joins to a segment, the communication terminal 1 sends a segment entry notification M114 to the segment manager. The communication control part 12 of the segment manager receives the notification via the short range wireless communication interface 11, and then the communication control part 12 notifies the segment management part 13 the information. The segment management part 13 that has received the segment entry notification M114 enters information of the communication terminal 1 to the segment information DB 22 (step S301). In addition, the segment management part 13 sends internal terminal information notification M118 to the segment managers of other segments via the communication control part 12 and the long range wireless communication interface 14 (also referred to as “L. WIRELESS INTERFACE” in the figures”).

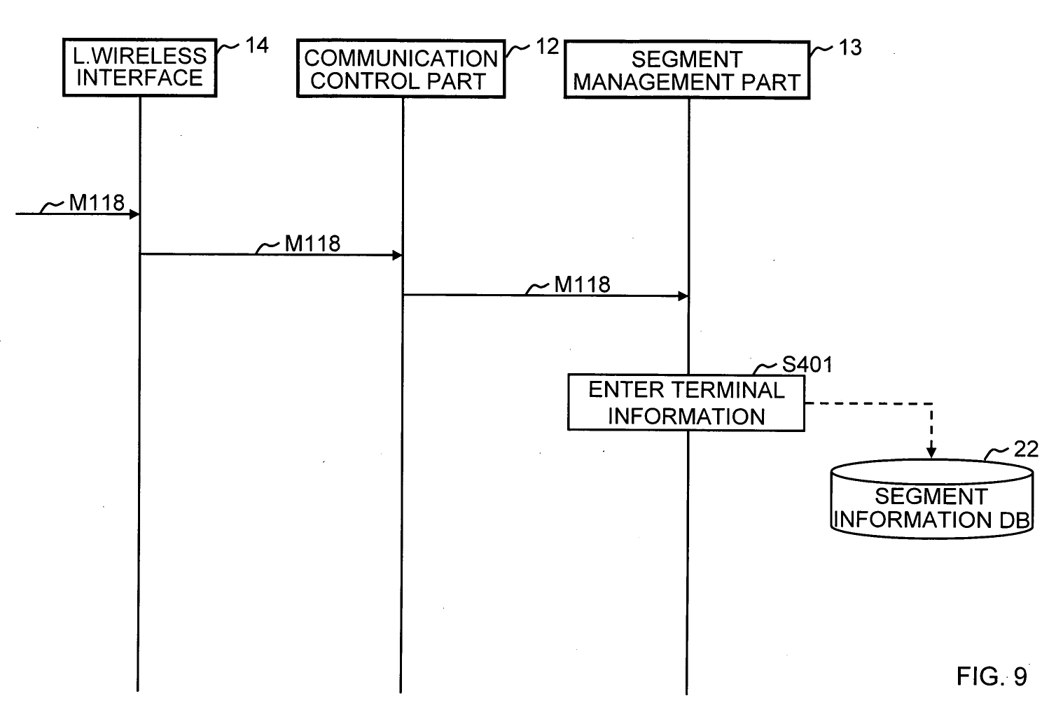

FIG. 9 shows a process sequence in which external terminal information is entered in the segment manager. The entry of information of a communication terminal 1 in another segment will be described with reference to FIG. 9. As described above, when the communication terminal 1 has joined the segment, the segment manager sends the internal terminal information notification M118 to segment managers of other segments. The communication control part 12 of each segment manager receives the notification via the long range wireless communication interface 14, and then the communication control part 12 notifies the segment management part 13 the information. The segment management part 13 that has received the internal terminal information notification M118 of another segment enters the terminal information to the segment information DB 22 (step S401).

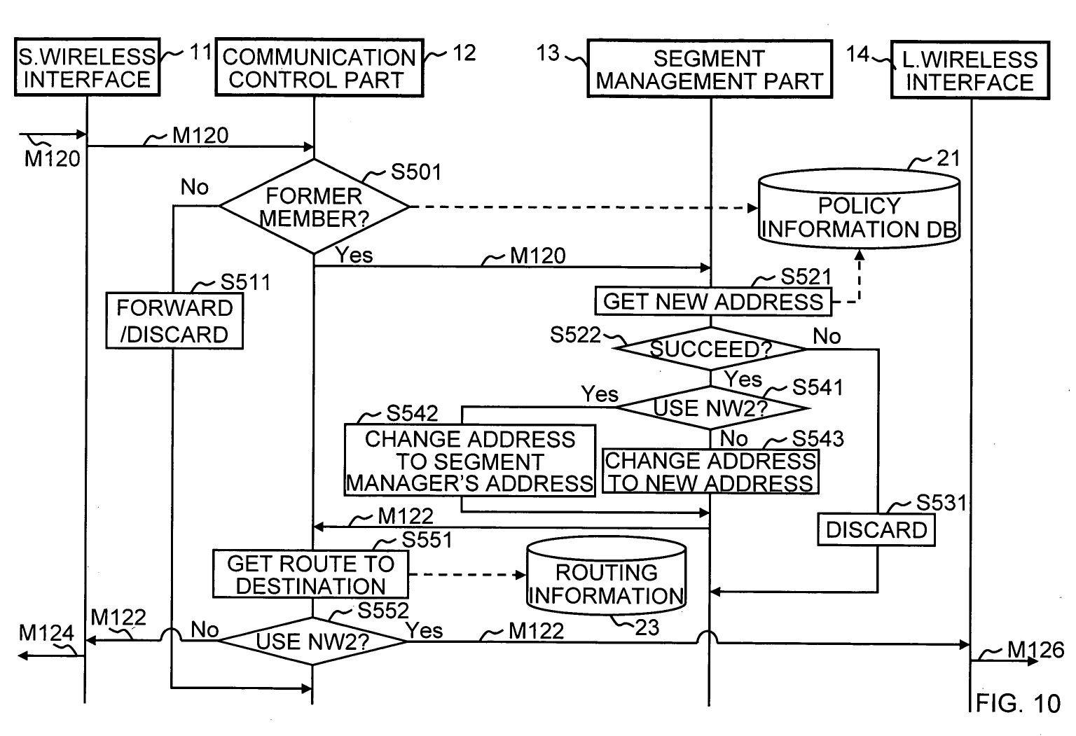

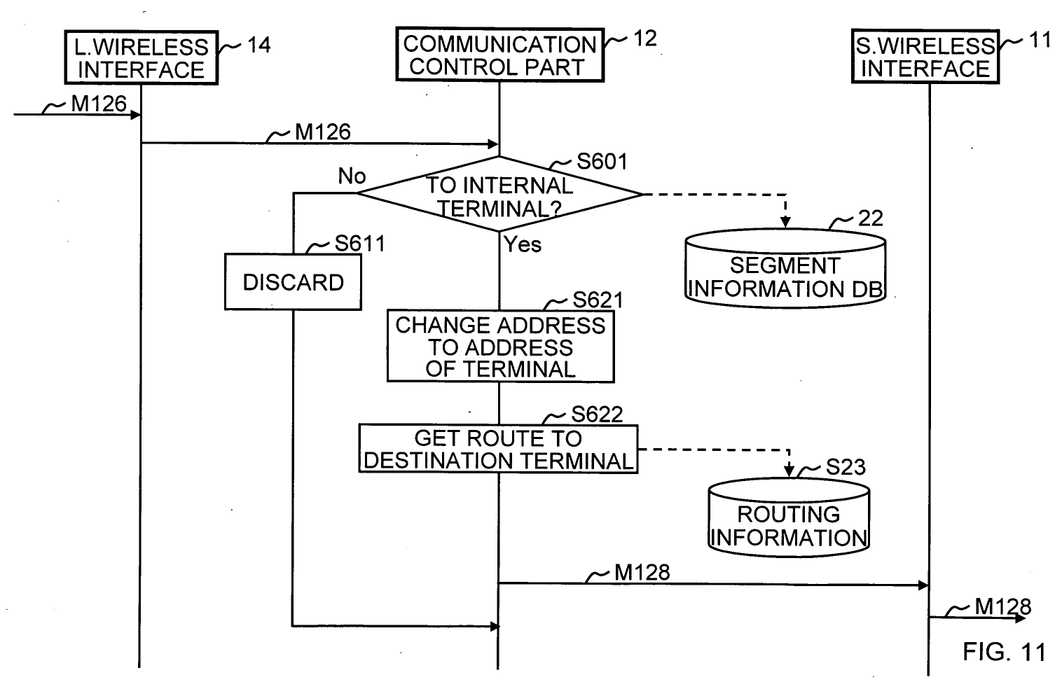

The process sequence of packet forwarding when a segment manager has received a data packet addressed to the communication terminal 1 that has shifted out to another segment will be described with reference to FIGS. 10 and 11. FIG. 10 shows a process sequence in which a data packet addressed to an external communication terminal 1 is forwarded by the segment manager of the source segment. When a communication terminal 1 has shifted out from a segment, another communication terminal 1 that has been communicating with the shifted communication terminal 1 may not be able to recognize the shift immediately. In such a case, a data packet M120 addressed to the shifted communication terminal 1 is sent to the address before the shift. This data packet M120 reaches, by means of LANMAR, the segment manager of the segment to which the shifted communication terminal 1 has formerly belonged. The communication control part 12 of the segment manager receives the data packet M120 as reception information via the short range wireless communication interface 11. The communication control part 12 determines whether or not the data packet M120 is addressed to the communication terminal 1 that has formerly belonged to the segment on the basis of information on terminals that LANMAR keeps and the internal terminal information stored in the segment information DB 22 (step S501). When the data packet M120 is addressed to the communication terminal 1 that has formerly belonged to the segment, the communication control part 12 notifies the segment management part 13 of the data packet M120. The segment management part 13 retrieves information of the destination segment (the address of the shifted communication terminal 1 in the destination segment and the address of the segment manager of the destination segment) from the segment information DB 22 (step S521 and step S522). When the retrieval is unsuccessful, this data packet M120 is discarded (step S531). When the retrieval is successful, the segment management part 13 references the number of hops between the segment managers in the secondary ad hoc network (NW2) and then determines whether (a) to forward the data packet M120 through the primary ad hoc network (NW1) that is split into segments or (b) to forward the data packet M120 through the secondary ad hoc network (NW2) constituted with the segment managers (step S541).

When in the case (a), the segment management part 13 changes the destination address of the forwarding data packet M120 to the address after the communication terminal 1 has shifted (step S543). The segment management part 13 sends a data packet forwarding request M122 to the communication control part 12 to forward the data packet M124 to the shifted communication terminal 1.

When in the case (b), the segment management part 13 changes the destination address to the address of the segment manager of the destination segment (step S542) and sends a data packet forwarding request M122 to the communication control part 12. In addition, the segment management part 13 adds the link local address information of the destination communication terminal 1 to this forwarding data packet M126.

The communication control part 12 acquires information on a route to the destination (the shifted communication terminal or the segment manager) from the routing information 23 (step S551). The information on the route includes information of a communication terminal 1 as a next hop and information of a wireless communication interface to be used. Then, in the case (a), the communication control part 12 forwards the data packet forwarding request M122 to the short range wireless communication interface 11, so as to forward the data packet M124 to the destination communication terminal 1, or in the case (b), the communication control part 12 forwards the data packet forwarding request M122 to the long range wireless communication interface 14, so as to forward the data packet M126 to the segment manager of the destination segment (step S552).

FIG. 11 shows a process sequence in which a data packet M126 forwarded from the source segment is forwarded within a destination segment. When in the case (b), referring to FIG. 11, the communication control part 12 of the segment manager of the destination segment receives the forwarded data packet M126 via the long range wireless communication interface 14. The communication control part 12 retrieves, from the segment information DB 22, information of a communication terminal 1 having the same link local address included in the data packet M126, in order to determine whether or not the destination communication terminal 1 belongs to its own segment (step S601). When the data packet M126 is addressed to a communication terminal 1 that belongs to its own segment, the communication control part 12 changes the destination address to the internal segment address which is the address for use within the segment (step S621). The communication control part 12 acquires information on a route from the routing information 23 (step S622). The information on the route includes information of a communication terminal 1 as a next hop and information of a wireless communication interface to be used. The communication control part 12 then forwards a data packet M128 to the next hop communication terminal 1 via the short range wireless communication interface 11. When the data packet M126 is not addressed to a communication terminal 1 that belongs to its own segment, the data packet M126 is discarded (step S611).

As described above, a segment manager is determined by a plurality of communication terminals 1 from among a plurality of neighboring communication terminals 1 each having the short range wireless communication interface 11. The segment manager distributes segment information to neighboring communication terminals 1 via the short range wireless communication interface 11. The segment manager joins a secondary ad hoc network (NW2) constituted with other segment managers. The segment managers mutually receive terminal information related to the segments managed by the segment managers via the long range wireless communication interface 14. Communication within the segment is performed through the own segment alone. Communication with the outside of the segment is performed through its own segment and another segment, and further the secondary ad hoc network (NW2) in some cases. A segment manager of a segment receives terminal information related to another segment without using its own segment, thus making it possible to reduce network traffic across its segment. In addition, even when a communication terminal 1 within a segment and a communication terminal 1 within another segment are not able to physically establish communication through only the segments, communication may be established through the secondary ad hoc network (NW2). Furthermore, when multiple segments are required to establish communication between a communication terminal 1 within a segment and a communication terminal 1 within another segment, communication via less number of intervening communication terminals 1 may be realized through the secondary ad hoc network (NW2).

Segment managers exchange terminal information through the secondary ad hoc network (NW2). The terminal information includes information indicating the correspondence between a unique address of a communication terminal 1 and an address dynamically assigned to the communication terminal 1. When a communication terminal 1 which belongs to one segment attempts to communicate with another communication terminal 1 which belongs to another segment, the segment manager acquires the dynamically assigned address on the basis of the unique address of the destination communication terminal 1. Communication between the communication terminals 1 which belong to different segments is established utilizing addresses determined on the basis of the unique address and the dynamically assigned address of each communication terminal 1. Thus, even when the communication terminal 1 shifts from one segment to another segment, the segment manager is able to acquire an address that is assigned to the shifted communication terminal 1 when joined the other segment, thus making it possible to establish communication with the shifted communication terminal 1.

The exchange of terminal information, among segment managers through the secondary ad hoc network (NW2), may be triggered at a predetermined interval. It may also be triggered on the segment manager's detection of the change in the state of its segment (that is, when a new communication terminal 1 joined, when a communication terminal 1 which belongs to the segment disappeared, or when a communication terminal 1 shifted), so as to make it possible to quickly establish communication with the communication terminal 1 just after changing the segments.

A segment manager on the source communication terminal 1 side specifies a segment manager of a segment to which a destination communication terminal 1 currently belongs, on the basis of the unique address of the destination communication terminal 1. The segment manager on the source communication terminal 1 side sends information to the specified segment manager on the destination communication terminal 1 side, so as to make it possible to establish communication with the destination communication terminal 1. Thus, the number of hops may be reduced, which is required to establish communication between communication terminals 1 which belong to different segments.

The segment manager calculates the number of hops from a source communication terminal 1 to a destination communication terminal 1 and determines, on the basis of the calculated number of hops, whether to communicate using the primary ad hoc network (NW1) or to communicate using the secondary ad hoc network (NW2). Thus communication may be established through a suitable route.

The segment manager detects a communication terminal 1 that has shifted out from its own segment, keeps the address information of the detected communication terminal 1 for a certain period of time, and then, in response to a communication request to the shifted communication terminal 1 from another communication terminal 1 in the same segment, changes a destination address from an address before shifting to an address after shifting. Thus, it is possible to realize a seamless communication with the communication terminal 1 that has shifted.

The manners of detecting a shift of a communication terminal 1 includes LANMAR's manner in which a comparison is made between a routing table and segment information (only the segment information includes information on the communication, terminal), a manner of comparing its own segment information with terminal information, a manner of asking another segment manager by picking up communication terminals 1 that do not respond for a certain period of time, or the like.

The segment manager is determined on the basis of at least one of following conditions: (1) whether or not another segment manager exists within a prescribed area around communication terminals 1 that are hopped upon communication; (2) whether or not the communication terminal 1 itself is a candidate of a segment manager; and (3) whether or not the communication terminal 1 has a higher priority to become a segment manager than those of other communication terminals 1.

An appropriate communication terminal 1 can become a segment manager on the basis of the above conditions. From the first condition, the number of segment managers and the number of communication terminals 1 that belong to the segment may be made appropriate. When the number of segment managers is large and the number of communication terminals 1 that belong to each segment is small despite a sufficient coverage area, the number of communications toward the outside of the own segment increases to thereby increase communication control processing. On the other hand, when the number of segment managers is small and the number of communication terminals 1 that belong to each segment is large, the processing load of each segment manager increases. When the second condition is not satisfied, a communication terminal 1 cannot become a segment manager by its nature. From the third condition, communication terminals 1 become segment managers in order of suitability for segment managers, thus making it possible to realize an appropriate communication control. For example, if a communication terminal 1 having a low processing capacity or a less battery capacity becomes a segment manager, it is more likely to have a situation where communication control cannot be executed. Therefore, it is desirable that such communication terminals 1 are removed from the candidates for the segment managers in advance, so as not to become a segment manager.

### Second Embodiment of the Present Invention

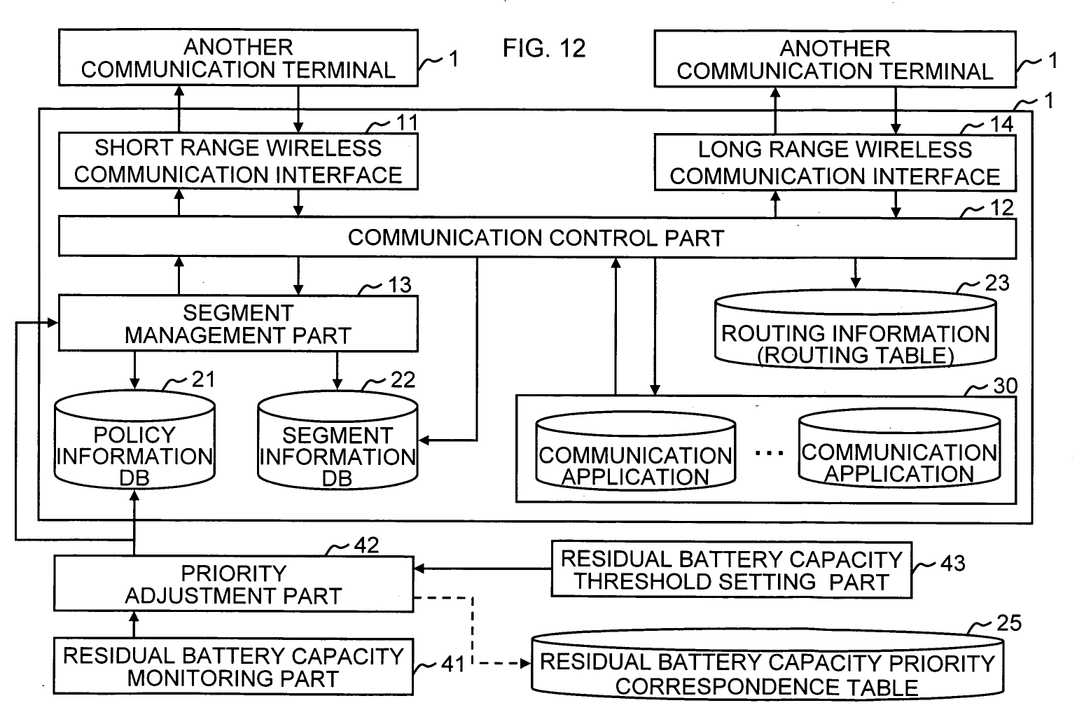

FIG. 12 is a functional block diagram of a communication terminal 1 according to a second embodiment of the present invention.

The manner of configuring a segment in an ad hoc network according to the second embodiment is the same as that of the first embodiment. However, the second embodiment differs from the first embodiment in the following. The communication terminal 1 includes a residual battery capacity monitoring part 41 and a priority adjustment part 42. The residual battery capacity monitoring part 41 monitors the residual battery capacity and outputs the residual battery capacity. The priority adjustment part 42 receives the residual battery capacity from the residual battery capacity monitoring part 41, references a residual battery capacity priority correspondence table 25, and then determines priority in accordance with the residual battery capacity. When the priority after the determination does not coincide with the current priority, the priority adjustment part 42 updates the priority information stored in the policy information DB 21 to the priority information after the determination via the segment management part 13. Furthermore, the segment manager, when the residual battery capacity acquired from the residual battery capacity monitoring part 41 is equal to or lower than the threshold value, transfers its authority of the segment manager to another communication terminal 1.

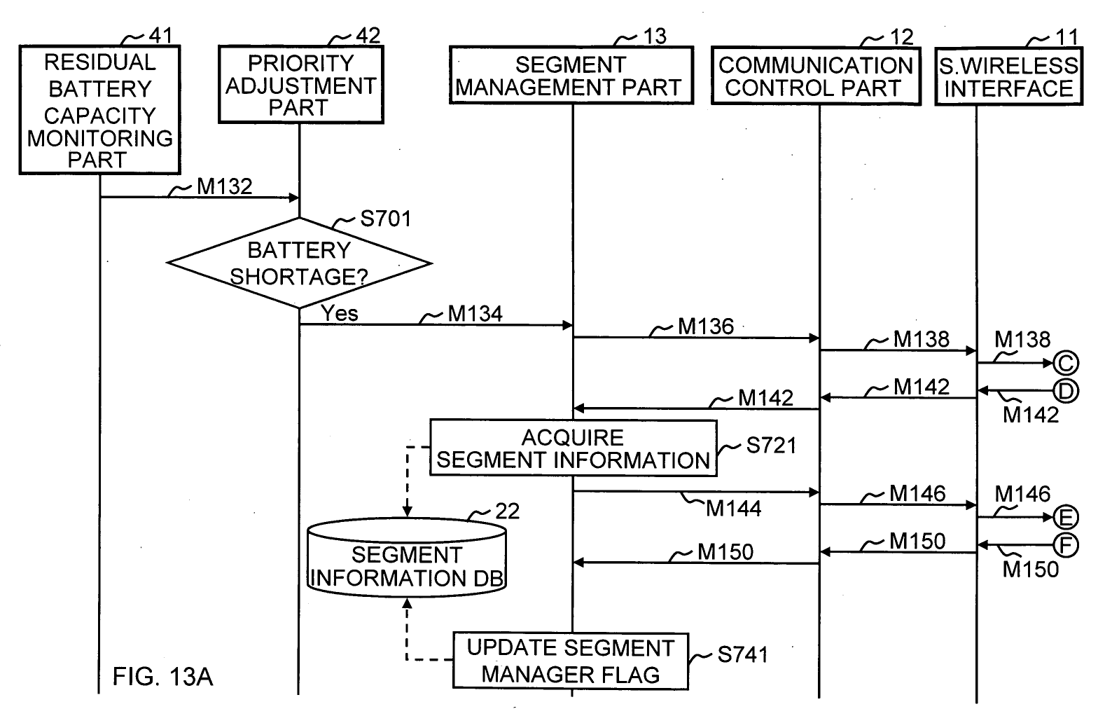

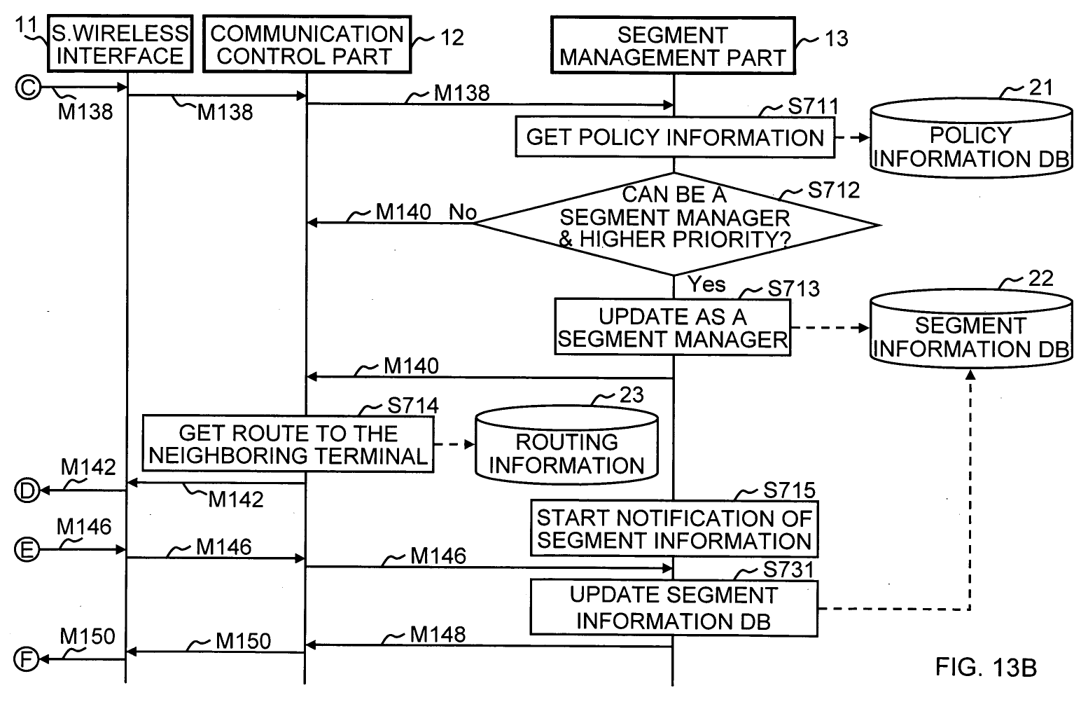

FIGS. 13A and 13B show a process sequence of authority transfer process of a segment manager. FIG. 13A shows a process sequence of a segment manager which is running short of battery capacity. FIG. 13B shows a process sequence of a neighboring communication terminal 1 of the segment manager. The residual battery capacity monitoring part 41 sends a residual battery capacity notification M132 to the priority adjustment part 42. The priority adjustment part 42 determines whether or not the residual battery capacity is equal to or lower than a threshold value (step S701) and, when it is determined that the residual battery capacity is equal to or lower than the threshold value, sends a manager authority transfer request M134 to the segment management part 13. The segment management part 13 sends a manager authority transfer notification transmission request M136 to the communication control part 12. The communication control part 12 transmits the manager authority transfer notification M138 via the short range wireless communication interface 11.

The communication terminal 1 receives the manager authority transfer notification M138 from the segment manager and executes a process described in FIG. 13B. The communication control part 12 receives the manager authority transfer notification M138 via the short range wireless communication interface 11 and then sends the manager authority transfer notification M138 to the segment management part 13. The segment management part 13 acquires policy information from the policy information DB 21 (step S711). The segment management part 13 determines whether or not the communication terminal 1 itself can become a segment manager and has a higher priority for the segment manager than the notification source communication terminal 1 (step S712). When the communication terminal 1 itself cannot become a segment manager or has a priority equal to or lower than the notification source communication terminal 1, the segment management part 13 sends a manager authority transfer response transmission request M140 to the communication control part 12 in order to return “manager authority transfer NG” response to the notification source communication terminal 1. When the communication terminal 1 itself can become a segment manager and has a priority higher than the notification source communication terminal 1, the communication terminal 1 itself becomes a segment manager. The segment management part 13 updates the segment information DB 22 in order to indicate that the communication terminal 1 operates as a segment manager (step S713), and sends a manager authority transfer response transmission request M140, as a segment information DB takeover request, to the communication control part 12 in order to return “manager authority transfer OK” response to the notification source communication terminal 1. Note that the manager authority transfer response transmission request M140 and the segment information DB takeover request may be separately sent. The communication control part 12 acquires, from the routing information 23, information on a route to the notification source communication terminal 1 (step S714) and then transmits the manager authority transfer response transmission request M140. Hereinafter, for explaining the case of “manager authority transfer OK”, the manager authority transfer response transmission request M140 is referred to as a segment information DB takeover request M140, and the notification source communication terminal 1 is referred to as the former segment manager.

The communication control part 12 of the former segment manager receives the segment information DB takeover request M140 via the short range wireless communication interface 11 and then notifies the segment management part 13 of the segment information DB takeover request M140. The segment management part 13 acquires segment information from the segment information DB 22 (step S721) and sends a segment information transmission request M144 to the communication control part 12. The communication control part 12 transmits the segment information M146 to the new segment manager via the short range wireless communication interface 11.

The new segment manager updates the segment information DB 22 in accordance with the segment information M146 received (step S731). After updating, the new segment manager transmits a takeover completion notification M150 to the former segment manager. The communication control part 12 of the former segment manager receives the takeover completion notification M150 via the short range wireless communication interface 11 and then notifies the segment management part 13 of the takeover completion notification M150. The segment management part 13 updates a segment manager flag stored in the segment information DB 22 (step S741).

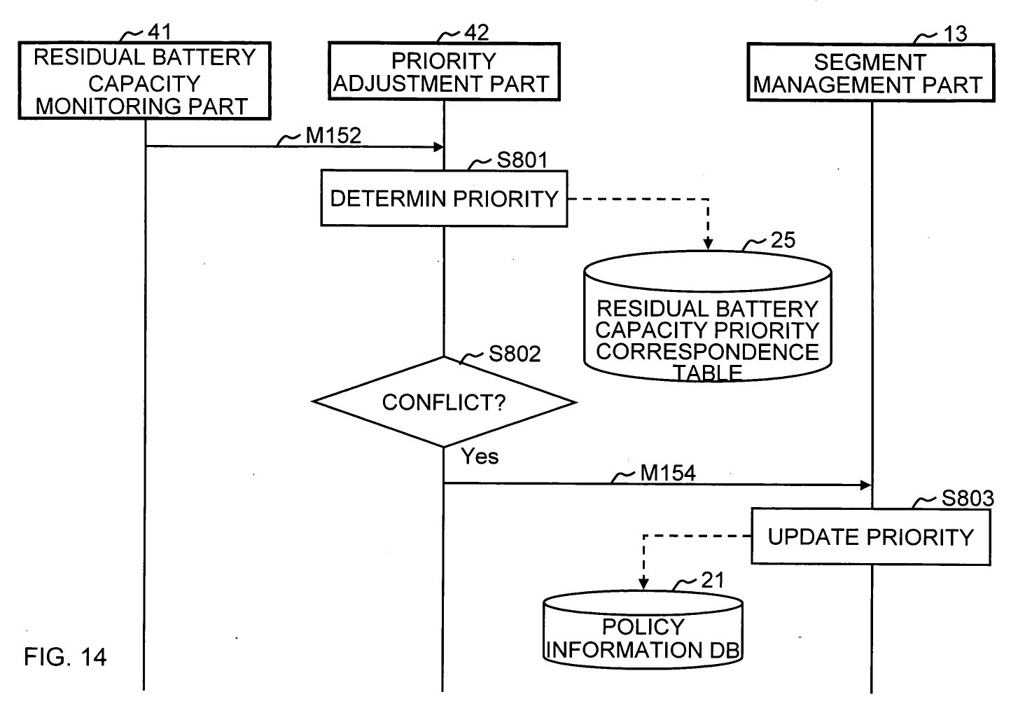

FIG. 14 is a process sequence of priority adjustment process of a communication terminal 1. The residual battery capacity monitoring part 41 notifies the priority adjustment part 42 of the residual battery capacity M152. The priority adjustment part 42 determines a priority in accordance with the residual battery capacity M152 with reference to the residual battery capacity priority correspondence table 25 (step S801). The priority adjustment part 42 determines whether or not the determined priority conflicts with the current priority (step S802). When it conflicts, the segment management part 13 updates the priority information stored in the policy information DB 21 (step S803).

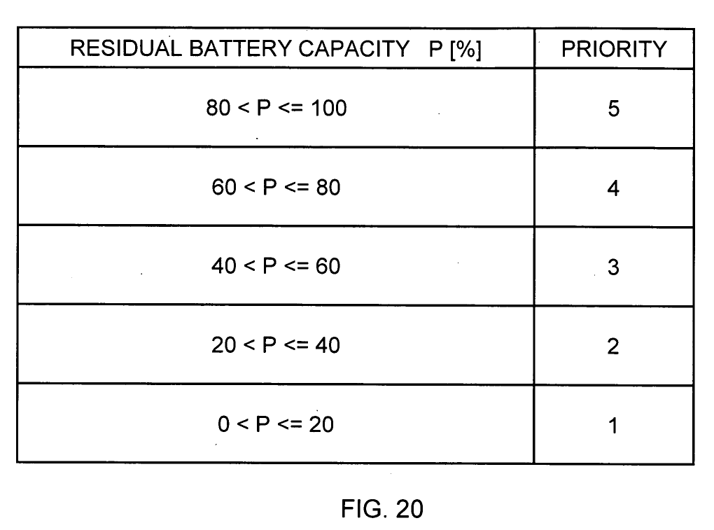

FIG. 20 shows an example of the residual battery capacity priority correspondence table 25.

As described above, it may be such a configuration that, when the residual battery capacity of a segment manager is equal to or lower than a predetermined threshold value, the authority of segment manager is transferred to another communication terminal 1 within the same segment. In this manner, an appropriate communication terminal 1 becomes a segment manager to maintain smooth ad hoc network communication. In addition, it may be such a configuration that the priorities of communication terminals 1 are varied in accordance with the residual battery capacity of communication terminals 1. When the current segment manager transfers its authority of segment manager to a communication terminal 1 within the same segment, the communication terminal 1 accepts the authority transfer if its priority is higher than that of the current segment manager and becomes a segment manager. In this manner, it is determined in advance that a new segment manager is more suitable for a segment manager than the current segment manager, so that a regressive authority transfer may be prevented.

On determining the first segment manager of a new segment, the segment manager is determined on the basis of information whether or not another segment manager exists within a prescribed number of communication terminals 1 hopped upon communication, information whether or not the communication terminal 1 itself is a candidate for segment managers, and its priority to become a segment manager.

### EXAMPLES

Five examples that explain situations of the primary ad hoc network (NW1) according to the present invention will be described. The five examples include transformation into a segment manager, entry of a communication terminal 1 to a segment, addition of a new segment manager, packet forwarding to a shifted communication terminal 1 through the secondary ad hoc network (NW2), and packet forwarding to a shifted communication terminal 1 through the primary ad hoc network (NW1).

### First Example

### Transformation into Segment Manager

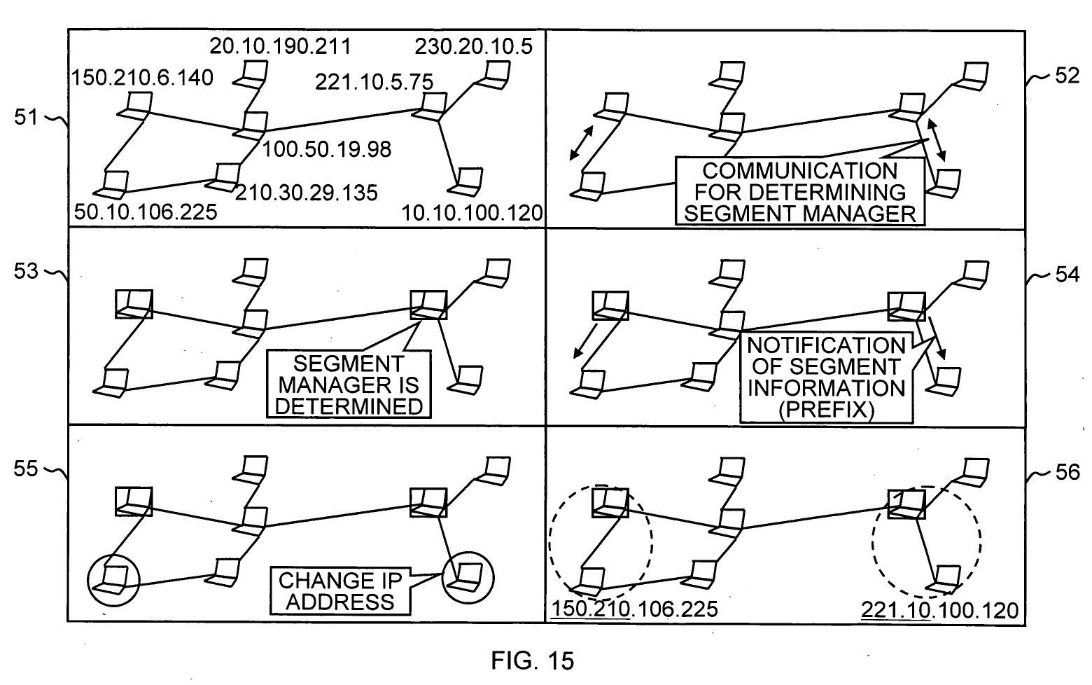

FIG. 15 explains the first example. The first example describes a sequence of states when a segment is formed within a primary ad hoc network (NW1) (namely, a communication terminal 1 transforms into a segment manager), wherein no segment exists at the beginning.

(State 51) Each communication terminal 1 joins a primary ad hoc network (NW1) with an IP address (a link local address). For example, under IPv6 (Internet Protocol Version 6), each communication terminal 1 automatically sets an address of EUI (Extended Unique Identifier)-64 using duplicate address detection and then joins the primary ad hoc network (NW1).

(State 52) When a communication terminal 1 does not receive segment information for a certain period of time, the communication terminal 1 establishes communication with a neighboring communication terminal 1 to determine a segment manager.

(State 53) Following the state 52, a segment manager is determined.

(State 54) The communication terminal 1 that has become a segment manager notifies segment information (prefix information, etc.). For example, when EUI-64 is used under IPv6, the segment manager distributes, as the segment information, prefix information in which the leftmost 64 bits of its own IP address are used as a prefix.

(State 55) A communication terminal 1 that has received the segment information from the segment manager changes its own IP address on the basis of the received segment information. For example, when EUI-64 is used under IPv6, the leftmost 64 bits of its own IP address are replaced with the received prefix.

(State 56) Thus, a segment is formed.

### Second Example

### Entry of Communication terminal to the Segment

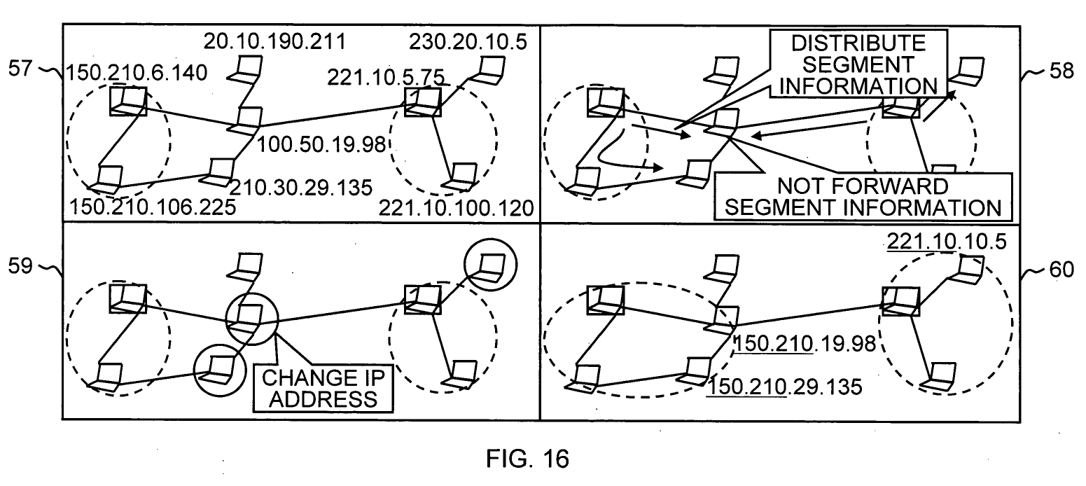

FIG. 16 explains the second example. The second example describes a sequence of states when a communication terminal 1 joins the segment (the number of constituent communication terminals 1 of the segment increases), wherein the communication terminal 1 does not belong to any segment at the beginning.

(State 57) This state is the same as the State 56 of the first example.

(State 58) The segment manager periodically distributes the segment information. A communication terminal 1 within the segment forwards the segment information, but a communication terminal 1 which does not belong to the segment does not forward the segment information.

(State 59) A communication terminal 1 that has received the segment information from the segment manager changes its own IP address on the basis of the received segment information.

(State 60) The number of constituent communication terminals 1 of the segment is thus increased.

### Third Example

### Addition of New Segment Manager

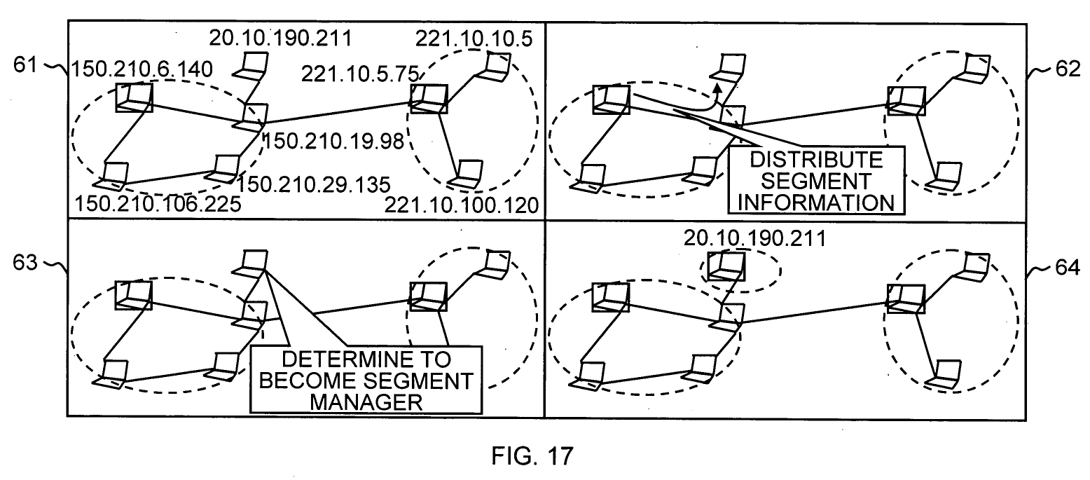

FIG. 17 explains the third example. The third example describes a sequence of states when a new segment (a new segment manager) is added, wherein some segments exist already.

(State 61) The state is the same as the State 60 of the second example.

(State 62) The segment manager periodically distributes the segment information.

(State 63) A communication terminal 1 that has received the segment information from the segment manager evaluates the received segment information according to the policy information and then determines not to join the segment but to become itself a segment manager. For example, as the policy, it is conceivable that a communication terminal 1 determines to go independent if it is located three or more hops away from the segment manager.

(State 64) The number of segments (segment managers) is thus increased by one.

### Fourth Example

### Packet Forwarding to Shifted Communication Terminal Through Secondary ad hoc Network (NW2)

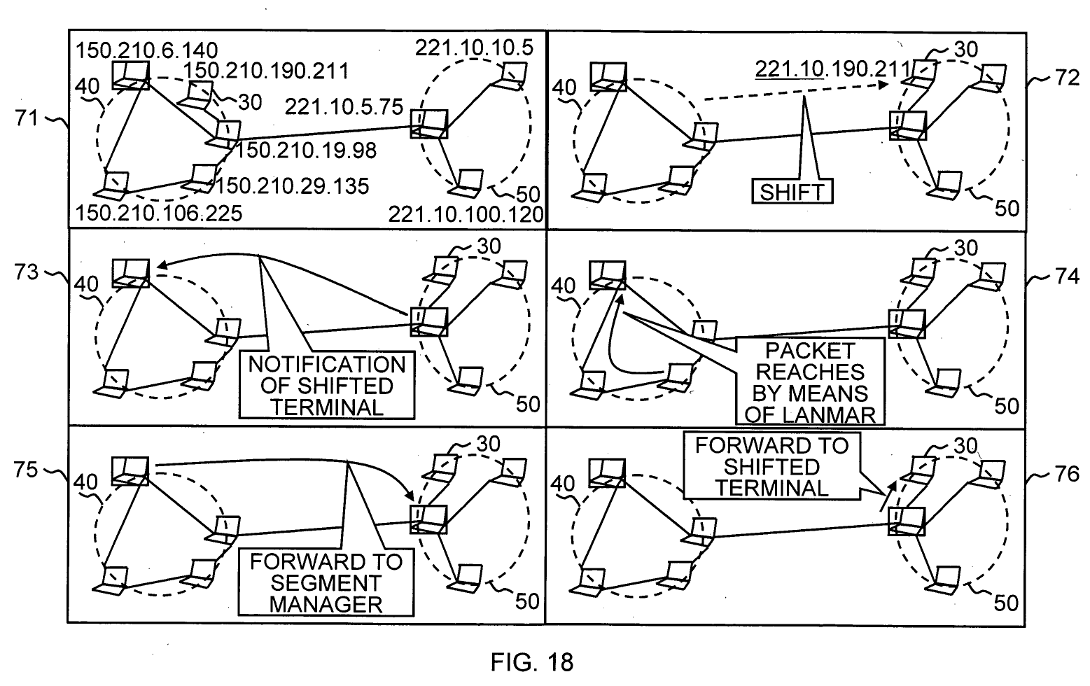

FIG. 18 explains the fourth example. The fourth example describes a sequence of states when a packet is forwarded to a shifted communication terminal 1 through a secondary ad hoc network (NW2).

(State 71) A communication terminal 30 belongs to a first segment 40, and has an address of 150.210.190.211.

(State 72) The communication terminal 30 shifts from the first segment 40 to a second segment 50, and changes its address to 221.10.190.211.

(State 73) The segment manager of the second segment 50 notifies other segment managers of the information on the communication terminal 30 that has joined the second segment 50. The segment manager of the first segment 40 receives the notification and stores the information. This notification is performed through the secondary ad hoc network (NW2) among the segment managers via the long range wireless communication interface 14.

(State 74) A packet addressed to the old address (150.210.190.211) of the communication terminal 30 reaches the segment manager of the first segment 40 by means of LANMAR.

(State 75) The segment manager of the first segment 40 detects a destination segment (the second segment 50) of the communication terminal 30 and then forwards the packet to the segment manager of the destination segment. This packet forwarding is performed through the secondary ad hoc network (NW2) among the segment managers via the long range wireless communication interface 14.

(State 76) The segment manager of the second segment 50 receives the packet from the segment manager of the first segment 40, and changes the destination address as to forward the packet to the communication terminal 30.

### Fifth Example

### Packet Forwarding to Shifted Communication Terminal Through Primary ad hoc Network (NW1)

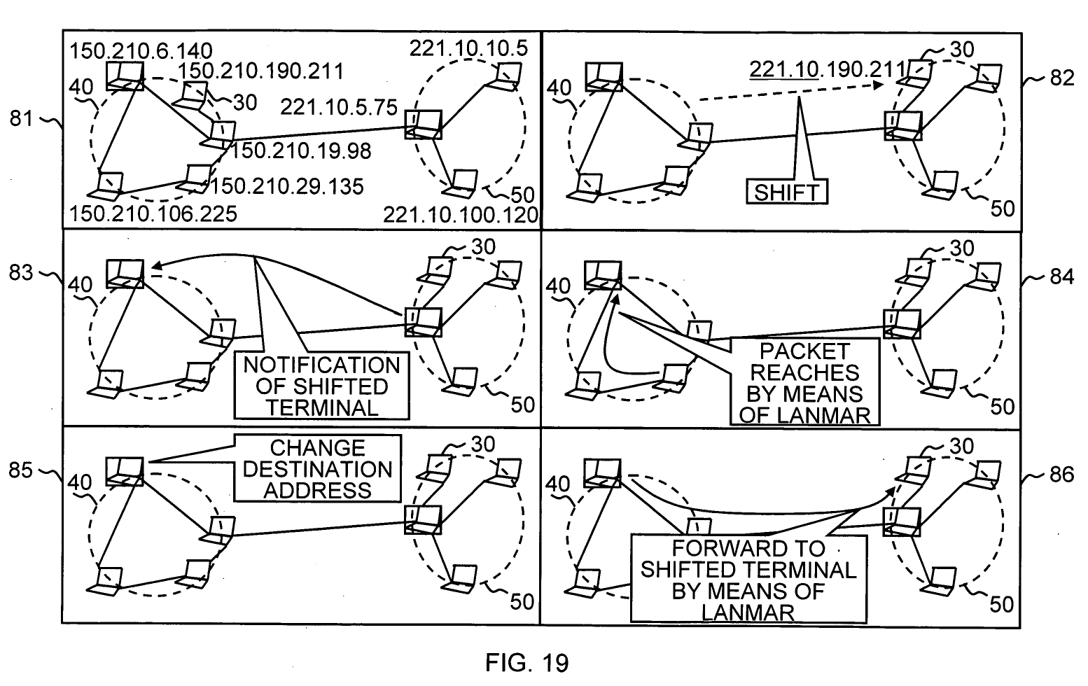

FIG. 19 explains the fifth example. The fifth example describes a sequence of states when a packet is forwarded to a shifted communication terminal 1 through a primary ad hoc network (NW1).

(State 81) A communication terminal 30 belongs to a first segment 40, and has an address of 150.210.190.211.

(State 82) The communication terminal 30 shifts from the first segment 40 to a second segment 50, and changes its address to 221.10.190.211.

(State 83) The segment manager of the second segment 50 notifies other segment managers of the information on the communication terminal 30 that has joined the second segment 50. The segment manager of the first segment 40 receives the notification and stores the information. This notification is performed through the secondary ad hoc network (NW2) among the segment managers via the long range wireless communication interface 14.

(State 84) A packet addressed to the old address (150.210.190.211) of the communication terminal 30 reaches the segment manager of the first segment 40 by means of LANMAR.

(State 85) The segment manager of the first segment 40 detects a destination segment (the second segment 50) of the communication terminal 30, and changes the destination address of the packet to an address in the destination segment as to forward the packet thereto.

(State 86) The packet that has forwarded from the segment manager of the first segment 40 reaches the communication terminal 30 by means of LANMAR.

The embodiments and examples of the present invention are thus described above, but these embodiments and examples are illustrative and not intended to be used to limit the scope of the present invention. These embodiments and examples may be changed or modified into various forms and equivalents within the scope of the present invention, which becomes apparent from the appended claims.

What is claimed is:

1. A communication terminal for performing communication through a primary network and communication through a secondary network, said primary network being split into a plurality of segments, said segment being constituted with a segment manager and subordinate terminals, said segment manager managing the segment, said communication terminal comprising:
a segment information storage for storing a first unique address of the communication terminal;
a first interface for performing communication through the primary network;
a second interface for performing communication through the secondary network;
a communication control part
for transmitting an offer of becoming a segment manager of a first segment via the first interface,
for receiving an approval for the offer via the first interface,
for transmitting prefix information indicating the first segment via the first interface,
for receiving a second unique address of a second subordinate terminal which joins the first segment via the first interface,
for transmitting the second unique address and the first unique address via the second interface, and
for receiving a fourth unique address of a fourth subordinate terminal which belongs to a third segment and a third unique address of a segment manager which manages the third segment via the second interface; and
a segment management part for generating the prefix information from the first unique address in a predefined manner.

2. The communication terminal of claim 1, said communication control part further
receiving a packet including a fifth destination address and a fifth unique address via the first communication interface,
forwarding the packet via the first interface when the fifth destination address indicates a subordinate terminal in the first segment, and
forwarding the packet via the second interface when the fifth destination address indicates a segment manager or a subordinate terminal in a segment other than the first segment.

3. The communication terminal of claim 1, further comprising:
a routing information storage for storing a triplet containing a destination address indicating an ultimate destination, a forwarding address indicating a present destination, and interface information indicating the first interface or the second interface,
said communication control part further
receiving a packet including a fifth destination address and a fifth unique address via the first communication interface,
forwarding, on finding a triplet containing the fifth destination address as the destination address in the routing information storage, the packet to the forwarding address contained in the found triplet via a communication interface indicated by the interface information contained in the found triplet, and
forwarding the packet to the third unique address via the second interface when the fifth destination address is able to be generated from the fourth unique address and the third unique address in a predefined manner.

4. The communication terminal of claim 2, said segment information storage further storing a sixth destination address and a seventh unique address, said sixth destination address being of a sixth subordinate terminal which has shifted out from the first segment, said seventh unique address being of a segment manager managing a seventh segment to which the sixth subordinate terminal belongs,
said communication control part, on receiving a packet including the sixth destination address, forwarding the packet to the seventh unique address via the second interface.

5. A method for performing communication through a primary network and communication through a secondary network, said primary network being split into a plurality of segments, said segment being constituted with a segment manager and subordinate terminals, said segment manager managing the segment, said method being executed by a communication terminal, said communication terminal including a segment information storage for storing a first unique address, a first interface, and a second interface, said first unique address being of the communication terminal, said first interface being for performing communication through the primary network, said second interface being for performing communication through the secondary network, said method comprising the steps of
transmitting an offer of becoming a segment manager of a first segment via the first interface;
receiving an approval for the offer via the first interface;
generating prefix information from the first unique address in a predefined manner;
transmitting the prefix information via the first interface;
receiving a second unique address of a second subordinate terminal which joins the first segment via the first interface;
transmitting the second unique address and the first unique address via the second interface; and
receiving a fourth unique address of a fourth subordinate terminal which belongs to a third segment and a third unique address of a segment manager which manages the third segment via the second interface.

6. The method of claim 5, further comprising the steps of:
receiving a packet including a fifth destination address and a fifth unique address via the first communication interface;
forwarding the packet via the first interface when the fifth destination address indicates a subordinate terminal in the first segment; and
forwarding the packet via the second interface when the fifth destination address indicates a segment manager or a subordinate terminal in a segment other than the first segment.

7. The method of claim 5, said communication terminal further including a routing information storage for storing a triplet, said triplet containing a destination address, a forwarding address, and interface information, said destination address indicating an ultimate destination, said forwarding address indicating a present destination, said interface information indicating the first interface or the second interface, said method further comprising the steps of
receiving a packet including a fifth destination address and a fifth unique address via the first communication interface;
on finding a triplet containing the fifth destination address as the destination address in the routing information storage, forwarding the packet to the forwarding address contained in the found triplet via a communication interface indicated by the interface information contained in the found triplet; and
forwarding the packet to the third unique address via the second interface when the fifth destination address is able to be generated in a predefined manner from the fourth unique address and the third unique address.

8. The method of claim 6, said segment information storage further storing a sixth destination address and a seventh unique address, said sixth destination address being of a sixth subordinate terminal which has shifted out from the first segment, said seventh unique address being of a segment manager managing a seventh segment to which the sixth subordinate terminal belongs, said method further comprising the step of,
on receiving a packet including the sixth destination address, forwarding the packet to the seventh unique address via the second interface.

9. A program storage medium readable by a computer, said program storage medium storing a program of instructions for the computer to execute a method for communication through a primary network and communication through a secondary network, said primary network being split into a plurality of segments, said segment being constituted with a segment manager and subordinate terminals, said segment manager managing the segment, said computer being installed in a communication terminal, said communication terminal including a segment information storage for storing a first unique address, a first interface, and a second interface, said first unique address being of the communication terminal, said first interface being for performing communication through the primary network, said second interface being for performing communication through the secondary network, said method comprising the steps of:
transmitting an offer of becoming a segment manager of a first segment via the first interface;
receiving an approval for the offer via the first interface;
generating prefix information from the first unique address in a predefined manner;
transmitting the prefix information via the first interface;
receiving a second unique address of a second subordinate terminal which joins the first segment via the first interface;
transmitting the second unique address and the first unique address via the second interface; and
receiving a fourth unique address of a fourth subordinate terminal which belongs to a third segment and a third unique address of a segment manager which manages the third segment via the second interface.

10. The program storage medium of claim 9, said method further comprising the steps of
receiving a packet including a fifth destination address and a fifth unique address via the first communication interface;
forwarding the packet via the first interface when the fifth destination address indicates a subordinate terminal in the first segment; and
forwarding the packet via the second interface when the fifth destination address indicates a segment manager or a subordinate terminal in a segment other than the first segment.

11. The program storage medium of claim 9, said communication terminal further including a routing information storage for storing a triplet, said triplet containing a destination address, a forwarding address, and interface information, said destination address indicating an ultimate destination, said forwarding address indicating a present destination, said interface information indicating the first interface or the second interface, said method further comprising the steps of:
receiving a packet including a fifth destination address and a fifth unique address via the first communication interface;
on finding a triplet containing the fifth destination address as the destination address in the routing information storage, forwarding the packet to the forwarding address contained in the found triplet via a communication interface indicated by the interface information contained in the found triplet; and
forwarding the packet to the third unique address via the second interface when the fifth destination address is able to be generated in a predefined manner from the fourth unique address and the third unique address.

12. The program storage medium of claim 10, said segment information storage further storing a sixth destination address and a seventh unique address, said sixth destination address being of a sixth subordinate terminal which has shifted out from the first segment, said seventh unique address being of a segment manager managing a seventh segment to which the sixth subordinate terminal belongs, said method further comprising the step of,
on receiving a packet including the sixth destination address, forwarding the packet to the seventh unique address via the second interface.
